(19) United States
(12) Patent Application Publication
(10) Pub. No.: US 2008/0005986 A1
(43) Pub. Date: Jan. 10, 2008

(54) Floating-wall base and method of installation

(76) Inventor: James Thompson, San Diego, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/825,191

(22) Filed: Jul. 3, 2007

Related U.S. Application Data
(60) Provisional application No. 60/818,459, filed on Jul. 5, 2006.
(60) Provisional application No. 60/818,451, filed on Jul. 5, 2006.

(51) Int. Cl. E04F 19/04; A47J 47/20

(52) U.S. Cl. 52/290

(57) ABSTRACT

One embodiment of the invention relates to a flashing adapted to support a sheet of material. The flashing comprises a recessed section including a front surface and a rear surface; a shelf section formed on a top portion of the recessed center section having a top surface sized with a greater width than a width of the sheet of material; and a support section formed as a bottom portion of the flashing, the support section includes a first portion angled to extend away from a front surface of the recessed center section and a second portion angled toward the rear surface of the recessed section.

This application claims the benefit of priority on U.S. Provisional Application No. 60/818,459 filed Jul. 5, 2006, and U.S. Provisional Application No. 60/818,451 filed Jul. 5, 2006.

### FIELD

Embodiments of the invention are generally directed to a flashing to protect against the accumulation of moisture and the development of unhealthy environmental conditions. According to at least one embodiment of the invention, the flashing is configured to operate as a baseboard while supporting a section of a wall or bordering of an external structure.

### GENERAL BACKGROUND

Over the last few decades, residential and commercial structures have undergone architectural transformations in an effort to reduce the overall costs of construction. Until the early 1970s, the interior walls for many buildings were made of plaster. The plaster was applied in layers over narrow boards, commonly referred to as “laths,” which were nailed directly to studs forming the framing for the structure.

Around that time, drywall, sometimes referred to as “plaster board” or “gypsum board,” came into widespread use as construction product for interior walls within a building such as a residence or commercial structure. Drywall is made of a paper liner wrapped around an inner core made primarily from gypsum plaster. Normally, drywall has a thickness ranging between ¼-inch and 1-inch. Homebuilders and contractors typically use ½-inch thick drywall in construction projects.

Like laths, drywall comes in sheets that are nailed to the studs. Typically, these sheets are arranged to form interior walls extending from the floor upward. Once the drywall is attached to the studs, the joints between sheets forming the wall are covered with a special tape which, along with the nail heads, are covered with a paste material commonly referred to as “joint compound”. Joint compound is used in order to hide the seams between the sheets of drywall.

After the drywall surface with the joint compound is sanded and holes are cut out for electrical outlets/switches and light fixtures, a decorative baseboard usually is attached to the bottom portion of the drywall. The baseboards made of a material harder than the drywall (e.g., wood or a hardened plastic material) in order to protect the drywall from damage. However, current interior wall construction involving the attachment of baseboards to the bottom of the drywall suffers a number of disadvantages.

One disadvantage is that current baseboards do not provide the drywall with any protection against water damage, as painfully experienced in 2005 by many homeowners in New Orleans and other seaside towns in the path of hurricane Katrina. Moisture tends to build up on drywall surfaces behind the baseboards, especially after flooding within a structure caused by a broken water pipe, overfilled bathtub, clogged toilet, or weather. This may cause mold to develop. Mold within a household or place of employment can cause potential health programs for residents and tenants. Various types of health programs may include allergic reactions, irritation of the eyes or respiratory tract, dizziness, fatigue, headaches, and other ailments. To combat potential mold problems, in many cases, the old drywall has to be removed and new drywall installed. This is a costly solution and a waste of natural resources.

For certain businesses, such as restaurants for example, it is not uncommon to find tile or plastic molding along the baseboards since the floors tend to be cleaned by wet mop. However, neither tile nor plastic baseboards solve mold and cleanliness issues because tiles, the grout between the tiles, and plastic materials forming the baseboards are somewhat porous in nature so that repeated exposure to water will likely cause the drywall behind the tile or plastic molding to become moist and susceptible to mold.

Therefore, it is desirable to create a wall construction and flashing product that would tend to improve health conditions within a residence or business and mitigate the chances of water damage due to minor flooding.

### BRIEF DESCRIPTION OF THE DRAWINGS

The invention may best be understood by referring to the following description and accompanying drawings that are used to illustrate embodiments of the invention.

FIG. 1 illustrates a first embodiment of a floating-wall flashing system implemented to support wall material above an area potentially exposed to water.

FIG. 2 is a first exemplary embodiment of the flashing of the floating-wall flashing system of FIG. 1.

FIG. 3 is a detailed, illustrative embodiment of the shelf section of the flashing of FIG. 2 that is adapted to support wall material.

FIG. 4 is an illustrative embodiment of the mounting plate of FIG. 1.

FIG. 5 is an illustrative embodiment of the coupling member of FIG. 1.

FIG. 6 is an illustrative embodiment of the outer corner-covering member of FIG. 1.

FIG. 7 is an illustrative embodiment of the inner corner-covering member of FIG. 1.

FIG. 8 is an illustrative embodiment of the operations for installation of floating-wall flashing of FIG. 2.

FIG. 9 illustrates a second embodiment of the floating-wall flashing system.

FIG. 10 illustrates a third embodiment of the floating-wall flashing system.

FIG. 11 illustrates the floating-wall flashing being implemented as facie board or molding.

### DETAILED DESCRIPTION

Embodiments of the invention may best be understood by referring to the description in accompanying drawings set forth herein. In general, according to one embodiment of the invention, a floating-wall flashing system provides an effective moisture barrier for both interior walls within a structure, such as a residence or commercial property for example, as well as outside, exterior walls. This wall construction prevents the accumulation of moisture and damage to wall material, such as drywall, in response to flooding along a floor or counter.

For clarity sake, descriptions of one embodiment of the invention are directed to the floating-wall flashing system of an interior wall that includes a flashing that is adapted with a recessed center section extending into a wall and a shelf section to support wall material (e.g., drywall, particle board, wood, etc.).

As described below, according to at least one embodiment of the invention, the flashing utilized for the floating-wall flashing system comprises a recessed center section bordered by a shelf section and a support section. The shelf section includes a flange extending upwardly from a top surface of the shelf section in order to prevent forward movement of the wall material when it is placed on and supported by a top surface of the shelf section. The support section is located on a bottom side of the center section opposite from the shelf section and is adapted to be resilient enough to support the flashing in a vertically oriented position, where the shelf section is positioned above the center section. According to one embodiment of the invention, the support section includes (i) an angularly oriented first portion, referred to as a “kick,” that extends away from a front surface of the center section and (ii) a second portion, referred to as a “hem,” that returns an edge of the kick toward a rear surface of the flashing. According to this embodiment of the invention, the flashing is made of a non-porous material such as a metal (e.g. stainless steel, copper, aluminum, etc.), plastic, water-resistant Styrofoam™ and the like. The non-porous material may be continuous in form.

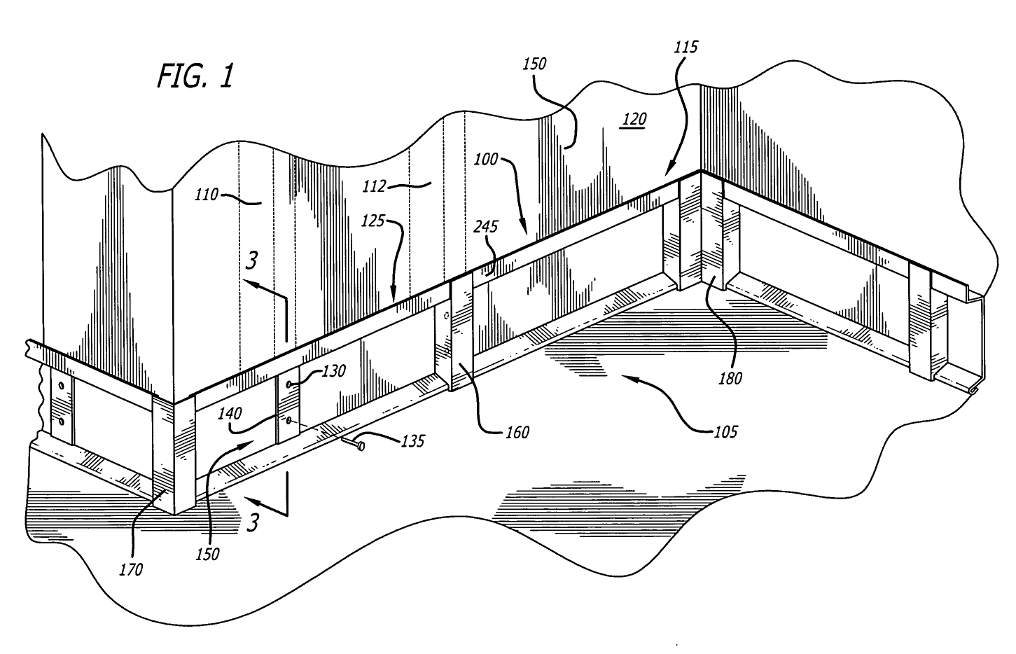

Referring to FIG. 1, a first embodiment of a floating-wall flashing system 100 implemented to support wall material 150 above an area 105 potentially exposed to water (e.g., floor, counter, etc.) is shown. Herein, floating-wall flashing system 100 comprises a flashing 125 that is attached to studs 110 and 112 partially framing a residential or commercial structure. According to this embodiment of the invention, flashing 125 is positioned to operate as a bottom section 115 of an interior wall 120 of the structure and supports wall material 150 such as a portion or entire sheet of drywall for example. One or more apertures 130 are either made (e.g., drilled, cut or etched at time of installation) or pre-formed (e.g., pre-drilled, pre-cut, etc.) into flashing 125 in order to assist in attaching flashing 125 to stud 110. If pre-formed, it is contemplated that multiple sets of apertures 130 may be formed into flashing 125, where these apertures 130 are separated by a predetermined distance generally equivalent to the spacing between studs.

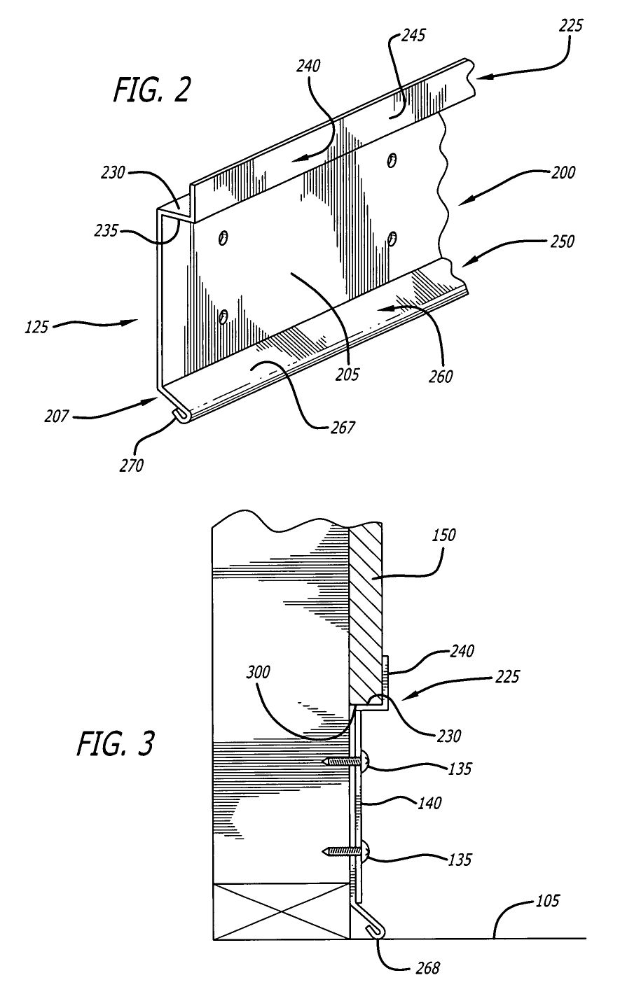

Referring now to FIG. 2, a first exemplary embodiment of flashing 125 is shown. Herein, flashing 125 comprises a recessed center section 200 bordered by a shelf section 225 and a support section 250. Center section 200 is recessed toward stud 110 of FIG. 1 to enable center section 200 to be generally linear with wall material 150 when it is placed on shelf section 225 (see FIG. 3). Alternatively, it is contemplated that flashing 100 may not include recessed center section 200, but rather, features any molding style as long as this molding includes a shelf section extending toward the studs in order to support the wall material above the ground.

As shown, shelf section 225 includes a flange 240 that extends upward from a top surface 230 of shelf section 225 in order to prevent forward movement of wall material 150 when positioned and maintained on top surface 230.

Support section 250 is located on an opposite side of center section 200 from shelf section 225 and is adapted to be resilient enough to support flashing 125 in a vertically oriented position. Support section 250 includes (i) an angularly oriented first portion 260, referred to as a “kick,” that extends away from a front surface 205 of center section 200 and (ii) a second portion 270, referred to as a “hem,” that returns an edge 265 of kick 260 towards a rear surface 207 of flashing 125. Kick 260 adds three-dimensional features to flashing 125 while hem 270 provides better stability and strength to flashing 125 in order to support wall material 150.

As further shown in FIG. 2, flange 240 extends upward by at least ⅛-inch and operates as a rail to prevent forward movement of wall material 150 resting on top surface 230 of shelf section 225. Top surface 230 of shelf section 225 ranges between ¼-inch to 1-inch in width for supporting wall material 150. Normally, the width of top surface 230 is approximately ⅝-inch, which is of a sufficient width to support standard drywall thickness.

At its top edge, center section 200 is recessed from flange 240 by a width substantially equivalent to the width of top surface 230. However, according to this embodiment of the invention, at its bottom edge, center section 200 is recessed by a lesser distance, namely the horizontal distance from edge 265 of kick 260 to front surface 205 of center section 200. Of course, it is contemplated that the recessed distances at the top and bottom edges may be equal or the recessed distance at the bottom edge may be greater than the recessed distance along the top edge.

Referring to FIGS. 1 and 2, fasteners 135 (e.g., screws) are inserted through apertures 130 in order to attach flashing 125 to studs 110 and 112. It is contemplated, however, that mounting plates 140 may be positioned over an area 150 of center section 200 that surrounds apertures 130 in order to mitigate moisture and dirt from entering through apertures 130. As shown, mounting plate 140 is positioned to be flush against front surface 205 of center section 200 and includes one or more apertures to be aligned with aperture(s) 130. In the event that apertures 130 are positioned near an end of flashing 125, mounting plate 140 may be further used to hide the seam formed between two different segments of flashing. Mounting plate 140 may feature decorative designs or indicia selected by the resident or tenant. The indicia may include advertisement information directed to the tenant or third party, logos, or any indicia selected by the resident or tenant.

In lieu of using mounting plates to cover a seam between two different segments of flashing or fasteners 140, floating-wall flashing system 100 may feature a coupling member 160 that is designed for placement within center section 200 of flashing 125. According to one embodiment of the invention, coupling member 160 covers portions of a front sidewall 245 of flange 240, front surface 205 of center section 200 and kick 260 of flashing 125 as shown in FIG. 2. Alternatively, it is contemplated that coupling member 160 may be adapted to only cover front surface 205 of center section 200 and/or kick 260 of flashing 125 if coupling member 160 fits snugly between a front surface 267 of kick 260 and a bottom surface 235 of shelf section.

As further shown in FIG. 1, floating-wall flashing system 100 may further include an outer corner-covering member 170 that is adapted to hide the seam formed between two segments of flashing at an outward facing corner of two neighboring walls. Similarly, an inner corner-covering member 180 is adapted to hide a seam formed by two different flashings intersecting at an interior corner of neighboring walls. Further illustration and discussion of outer corner-covering member 170 and inner corner-covering member 180 are described below in detail.

Referring now to FIG. 3, a detailed, illustrative embodiment of shelf section 225 adapted to support wall material 150 in a vertical orientation is shown. An edge 300 of wall material 150 is positioned to rest on top surface 230, normally having a width equal to or exceeding ⅝-inches. Flange 240 extends from top surface 230 to prevent forward movement of wall material 150 prior to its attachment to the studs. According to this embodiment of the invention, flange 240 and top surface 230 are formed from non-porous material such as a metal (e.g. stainless steel, copper, aluminum, etc.), plastic, water-resistant Styrofoam™ and the like. The non-porous material may be continuous in form.

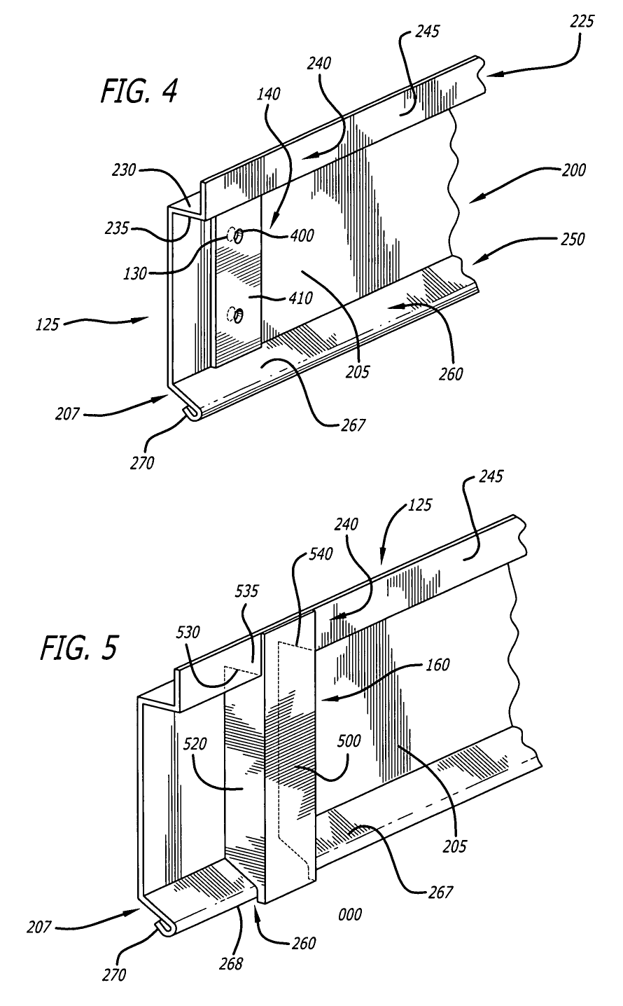

Referring to FIG. 4, an illustrative embodiment of mounting plate 140 illustrated in FIG. 1 is shown. Mounting plate 140 is a generally planar piece of material that is sized to fit within the recessed area formed by center section 200 between bottom surface 235 of shelf section 225 and a crease 255 denoting the starting point for kick 260. Mounting plate 140 includes at least one aperture 400 that can be aligned with aperture 130 made in flashing 125 to receive a fastener to be fastened to the studs. An outer surface 410 of mounting plate 140 may be coated with a material or mold-resistant chemical or may include advertisement information or other indicia such as logos to provide customization for different installations.

Referring now to FIG. 5, an illustrative embodiment of coupling member 160 is shown. Coupling member 160 includes a first plate 500 positioned between a first sidewall 520 and a second sidewall 540. According to one embodiment of the invention, first sidewall 520 and second sidewall 540 are formed to be substantially perpendicular to first plate 500. Of course, it is contemplated that one or more sidewalls 520 and/or 540 may be formed extending toward front surface 205 of flashing 125 as shown in FIG. 1, but at an obtuse or acute angle.

Coupling member 160 is adapted to be secured to and cover a segment of flashing 125 such as covering a seam formed by joining two different flashing segments. Coupling member 160 can be secured to flashing by forming sidewalls 520 and 540 to snugly fit with center section 200 and apply pressure against bottom surface 235 of shelf section 225 and kick 260 of FIG. 2. Alternatively, coupling member 160 can be affixed to flashing 125 by an adhesive or other attachment means.

As shown, according to this embodiment of the invention, first plate 500 extends upward to partially cover front sidewall 245 of flange 240 and extends downward to a bottom edge 268 of kick 260. A first end 530 of sidewall 520 is positioned to be complementary to and substantially flush against bottom surface 235 of shelf section 225. A second end 535 of sidewall 520 is angular and positioned to be complementary with and substantially flush against kick 260. Second sidewall 540 is configured identically as (and a mirror image of) first sidewall 520.

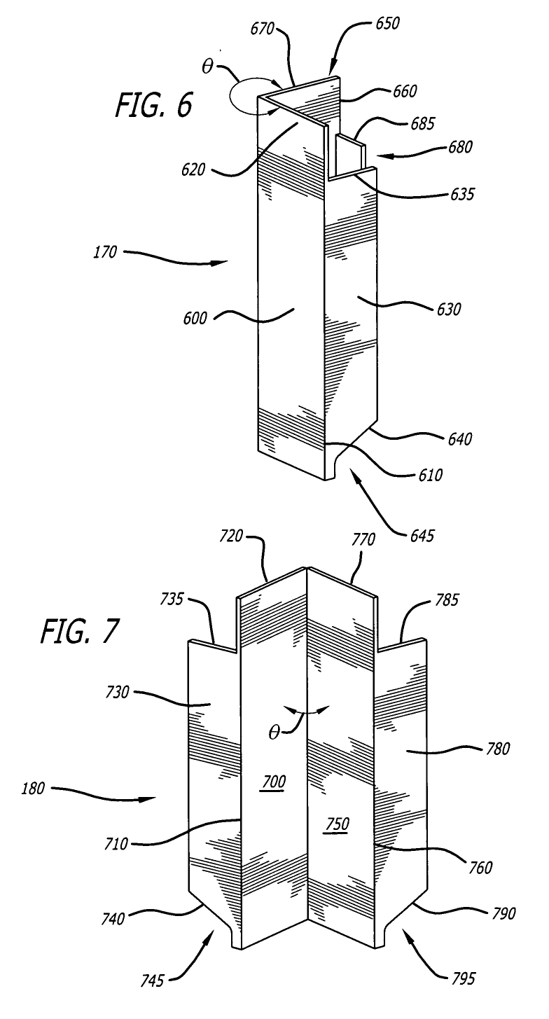

Referring to FIG. 6, an illustrative embodiment of an outer corner-covering member 170 of floating-wall flashing system 100 is shown. Outer corner-covering member 170 includes a first plate 600 and a second plate 650 that are substantially perpendicular to each other and having an internal angle θ of approximately 270 degrees. A first sidewall 630 is formed along an outer edge 610 of first plate 600 with a top edge 635 of first sidewall 630 being a predetermined distance below a top edge 620 of first plate 600. When installed, top edge 635 of first sidewall 630 is substantially flush with bottom surface 235 of shelf section 225 for a first flashing segment while an edge portion 640 toward a bottom edge 645 of first sidewall 630 is angular and substantially complementary with an angle of a kick of a first flashing segment.

According to this embodiment of the invention, second plate 650 is constructed substantially similar to first plate 600. More specifically, a second sidewall 680 is formed along an outer edge 660 of second plate 650. A top edge 685 of second sidewall 680 is also predetermined distance below a top edge 670 of second plate 650. When installed, top edge 685 of second sidewall 680 is substantially flush with bottom surface 235 of a shelf section for a second flashing segment while an edge portion (not shown) toward the bottom edge of second sidewall 680 is angular and substantially complementary with an angle of the kick of the second flashing segment.

Referring to FIG. 7, an illustrative embodiment of an inner corner-covering member 180 of floating-wall flashing system 100 is shown. Inner corner-covering member 180 includes a first plate 700 and a second plate 750 that are substantially perpendicular to each other and having an internal angle θ of approximately 90 degrees. A first sidewall 730 is formed along an outer edge 710 of first plate 700 with a top edge 735 of first sidewall 730 being a predetermined distance below a top edge 720 of first plate 700. When installed, top edge 735 of first sidewall 730 would be substantially flush with bottom surface 235 of shelf section 225 (see FIG. 1) for a first flashing segment while an edge portion 740 toward a bottom edge 745 of first sidewall 730 is angular and substantially complementary with an angle of the kick of the first flashing segment.

Second plate 750 is constructed substantially similar to first plate 700. More specifically, a second sidewall 780 is formed along an outer edge 760 of second plate 750. A top edge 785 of second sidewall 780 is also predetermined distance below a top edge 770 of second plate 750. When installed, top edge 785 of second sidewall 780 is substantially flush with a bottom surface of the shelf section of another flashing while an edge portion 790 toward a bottom edge 795 of second sidewall 780 is angular and substantially complementary with an angle of the kick of another segment of flashing.

To avoid seams, inner corner-covering member 180 is designed from a single piece of metal in which rounded (concave) edges are formed between first plate 700 and first sidewall 730 and second plate 750 and second sidewall 780. The rounded edge formed between first plate 700 and second plate 750 is generally convex in orientation.

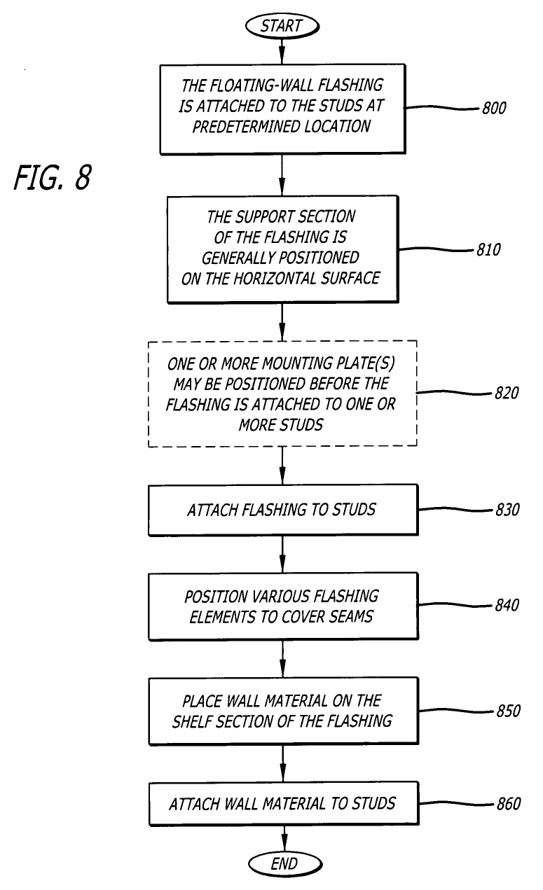

Referring now to FIG. 8, an illustrative embodiment of the operations for installation of floating-wall flashing that supports a wall section is shown. First, the floating-wall flashing is attached to the studs at a predetermined location (block 800). According to one embodiment of the invention, the support section of the flashing is generally positioned on the horizontal surface and the flashing is attached to the studs by screws or other fastening mechanisms (blocks 810 and 830). It is contemplated that, in lieu of screws, adhesive could be used and placed on the back surface of the flashing. Optionally, one or more mounting plate(s) may be positioned before the flashing is attached to one or more studs (block 820).

After attaching the flashing to the studs, various elements may be positioned along the flashing in order to cover seams between sections of flashing (block 840). This may be accomplished though the use of coupling members, outer corner-covering members and inner corner-covering members as described above. Thereafter, wall material is placed on the shelf section of the flashing and is attached to the studs as well so that the flashing operates as a support structure for the wall material (blocks 850 and 860).

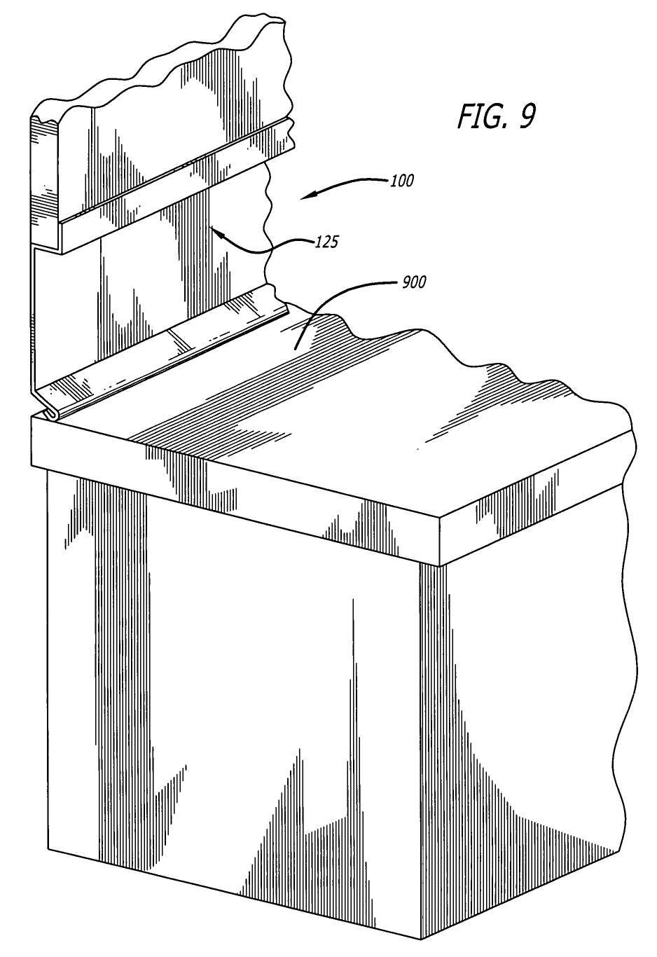

Referring now to FIG. 9, a second illustrative embodiment of floating-wall flashing system 100 is shown. Herein, area 900 is a horizontal surface, but it is not the floor of a structure. Rather, area 900 is a countertop in which moisture can accumulate. Hence, flashing 125 operates as a border for countertop 900.

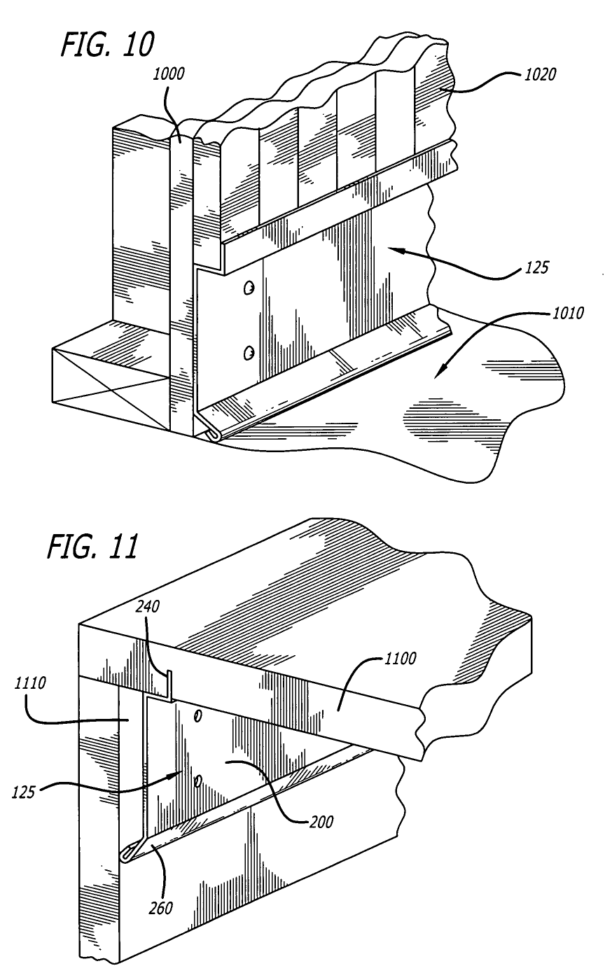

Referring now to FIG. 10, a third illustrative embodiment of floating-wall flashing system 100 is shown. This system operates similarly to wainscoting. Herein, flashing 125 is attached to a pre-existing drywall section 1000 located near the floor 1010. This retrofit implementation attaches flashing 125 to drywall 1000 and places additional wall material 1010 (e.g., decorative wood, laminate, glass, metal, etc.) onto flashing 125. Hence, flashing 125 and additional wall material 1010 collectively operate as wainscoting. As shown, flashing 125 supports a ⅜-inch thickness of finished wood in order to provide an easy-to-clean border and decorative wood accent along a substantial portion of the wall.

Referring now to FIG. 11, floating-wall flashing 125 may be implemented as facie board or molding in which flange 240 is inserted into a generally horizontal oriented material 1100 such as drywall or acoustic tiles forming the ceiling. With this implementation, however, kick 260 of flashing 125 would need to be angularly oriented toward the rear surface of center section 200 and a neighboring interior wall 1110 if it was desired to preclude visibility of the rear side of center section 200. Alternatively, hem 270 may be extended so that the edge of hem 270 is in contact with interior wall 1110. This would also prevent the accumulation of dirt and other contaminants.

Additionally, it will be evident that various modifications and changes may be made thereto without departing from the broader spirit and scope of the present invention as set forth in the appended claims. Therefore, the specification and drawings are accordingly to be regarded in an illustrative rather than in a restrictive sense.

What is claimed is:

1. A method comprising:
attaching a flashing to a portion of an existing structure, the flashing including a recessed center section and a shelf section formed on a top portion of the recessed center section;
placing an edge of a sheet of material onto the shelf section of the flashing; and
supporting the sheet of material on the shelf section of the flashing above a base floor.

2. The method of claim 1 wherein the flashing further includes a support section formed as a bottom portion of the flashing, the support section includes a first portion angled to extend away from the existing structure and a curved second portion extending from an edge of the first portion toward the existing structure.

3. The method of claim 2 wherein the first portion of the support section is a kick and the curved second portion of the support section is a hem.

4. The method of claim 2 wherein the existing structure includes a stud located within an interior wall of a building.

5. The method of claim 3, wherein the placing of the edge of the sheet of material includes placing of an edge of the sheet of drywall on a top surface of the shelf section.

6. The method of claim 4, wherein the base floor includes a floor of the building.

7. The method of claim 4 further comprising attaching the sheet of drywall to the stud.

8. A floating wall flashing system comprising:
a first segment of flashing including (i) a recessed center section and (ii) a shelf section formed on a top portion of the recessed center section and having a top surface sized with a width to support a sheet of material; and
at least one fastener adapted for attaching the first segment of flashing to an existing structure.

9. The floating wall flashing system of claim 8 wherein the recessed center section is substantially planar with the sheet of material when the sheet of material is positioned on the top surface of the recessed center section.

10. The floating wall flashing system of claim 8 wherein the first segment of flashing further includes a flange formed to extend from the shelf section.

11. The floating wall flashing system of claim 8 wherein the first segment of flashing further includes a support section formed on a bottom portion of the recessed center section, the support section includes a first portion angled to extend away from the existing structure and a curved second portion starting from an edge of the first portion toward the existing structure.

12. The floating wall flashing system of claim 10 further comprising a second segment of flashing including (i) a recessed center section and (ii) a shelf section formed on a top portion of the recessed center section, the second segment of flashing being aligned with the first segment of flashing so that the top surface of the first segment of flashing is linear with a top surface of the second segment of flashing.

13. The floating wall flashing system of claim 12 wherein the first segment of flashing further includes a first support section formed on a bottom portion of the recessed center section, the first support section including a kick extending at a first angle and a hem extending an edge of the first portion toward the existing structure.

14. The floating wall flashing system of claim 12 further comprising a coupling member positioned over a seam at an interconnection between the first segment of flashing and the second segment of flashing, the coupling member includes (i) a face plate covering a front sidewall of the flange and (ii) a plurality of side walls with a first edge positioned under a bottom surface of the shelf section of at least the first segment of flashing and a second edge proximate to the recessed center section.

15. The floating wall flashing system of claim 12 further comprising a mounting plate placed over and flush against the center recessed section of the first segment of flashing, the mounting plate includes indicia.

16. The floating wall flashing system of claim 12 further comprising an outer corner plate for covering a seam formed by the first segment of flashing and the second segment of flashing, the outer corner plate including a first face plate covering a portion of the recessed center section and substantially perpendicular with the second face plate.

17. The floating wall flashing system of claim 12 further comprising an inner corner plate for covering a seam formed by the first segment of flashing and the second segment of flashing, the inner corner plate including a first face plate substantially perpendicular with a first sidewall and a second face plate, where the second face plate is also perpendicular to a second side wall.

18. A flashing for supporting a sheet of material, comprising:
a recessed section including a front surface and a rear surface; and
a shelf section formed on a top portion of the recessed center section having a top surface sized greater than or equal to a width of the sheet of material and adapted to support the sheet of material.

19. The flashing of claim 18 further comprising:
a support section formed as a bottom portion of the flashing, the support section includes a first portion angled to extend away from a front surface of the recessed center section and a second portion angled toward the rear surface of the recessed section.

20. The flashing of claim 18 further comprising:
a flange extending upward from the top surface and adapted with a back surface of the flange being adjacent to the wall material.
